(19) United States
(12) Patent Application Publication
(10) Pub. No.: US 2026/0104269 A1
(43) Pub. Date: Apr. 16, 2026

(54) METHOD AND DEVICE FOR AUTOMATIC ZERO ADJUSTMENT OF INCLINOMETER USING GPS ALTITUDE AND LATITUDE AND LONGITUDE INFORMATION

(71) Applicants: Hyundai Motor Company, Seoul (KR); Kia Corporation, Seoul (KR)

(72) Inventor: Young Kwang Kim, Hwaseong-Si (KR)

(21) Appl. No.: 19/244,399

(22) Filed: Jun. 20, 2025

(30) Foreign Application Priority Data
Oct. 16, 2024 (KR) 10-2024-0141164

(51) Int. Cl. G01C 25/00; G01C 9/02

(52) U.S. Cl. CPC G01C 25/005; G01C 9/02

(57) ABSTRACT

A method performed by an apparatus associated with a moving object is introduced. The method may comprise obtaining data about a velocity of the moving object, a global positioning system (GPS) altitude, a GPS latitude, a GPS longitude, and a gradient associated with the moving object. The method may further comprise determining, based on integrating the data, an integrated altitude value, determining, based on the integrated altitude value, an observed inclination offset value, determining, based on the observed inclination offset value, inclination offset estimation data, automatically adjusting, based on the inclination offset estimation data, an inclination offset value of an inclinometer associated with the moving object, and outputting a signal indicating the adjusted inclination offset value.

### CROSS REFERENCE TO RELATED APPLICATION

The present application claims the benefit of priority to a Korean provisional application 10-2024-0141164, filed in the Korean Intellectual Property Office on Oct. 16, 2024, the entire contents of which are incorporated herein for all purposes by reference.

### TECHNICAL FIELD

The present disclosure relates to a method and device for automatic zero adjustment of an inclinometer of a moving object, and more particularly, to a method and device for automatic zero adjustment of an inclinometer of a moving object, which are capable of automatically adjusting the zero point of the inclinometer by using information on GPS altitude, GPS latitude and GPS longitude (hereinafter referred to as GPS latitude and longitude).

### BACKGROUND

The matters described in this Background section are only for enhancement of understanding of the background of the disclosure, and should not be taken as acknowledgment that they correspond to prior art already known to those skilled in the art.

A moving object (or moving device) driven on the ground is equipped with various types of sensors for detecting a state inside the moving object and an outside environment. Among the above-described sensors, an inclinometer (hereinafter also interchangeably referred to as inclination sensor) may detect and calculate an angle of inclination tilting the moving object according to a condition of a road surface, on which the moving object is running, and be managed by a controller such as a vehicle control unit (VCU). When an angle of inclination is calculated by an inclinometer, zero point information is used as a criterion, and the zero point information, which is also referred to as an offset value, may be stored and managed in a memory of a moving object such as a non-volatile memory.

Zero information may be adjusted according to periodical maintenance or a situation. A mechanic parks a moving object on a flat surface and uses a diagnostic tool for zeroing. Specifically, when the mechanic inputs a zero adjustment command into the diagnostic tool, a controller managing an inclinometer stores a current signal value of the inclinometer in a memory according to the command, and thus the moving object may be zeroed. However, if accurate velocity information is not provided according to a type of a GPS sensor (or Global Navigation Satellite System (GNSS) sensor) that is applied to a vehicle, or if no vertical velocity is provided, there may be a problem in that the automatic offset correction technique is unavailable.

In addition, the inclinometer may be subject to cumulative zero point drifts caused by a change of ambient temperature, and thus the existing zero point information may contain an error that may not be suitable for a current state. Erroneous zero point information of the inclinometer may cause a malfunction or error of the moving object. For example, functions affected by erroneous zero point information may be a function of estimating a weight of a moving object, control performance for weight-applied vehicles, and the like.

If an inclinometer fails in zero adjustment and has an error, the following malfunctions may occur in estimating a weight. An accident may occur in a parking situation or other situations where a moving object needs to be accurately controlled. By-products of erroneous zero point may include an excessive underestimated or overestimated amount of power generation necessary for a fuel cell, poor battery SOC management, and degradation of driving performance.

Accordingly, it is possible to consider a method for measuring or calculating an inclination of a moving object based on GPS, but the measurement of an inclination is difficult due to the following problems. Reliability of GPS-based measurement of inclinations may be present only if measurement is performed beyond a certain level of velocity. In addition, if a moving object is running a shadow area such as a tunnel or an underground parking lot, the GPS may not be able to measure current GPS latitudes and longitudes.

Accordingly, because an inclination may not be measured only with GPS data but needs to be obtained by an inclinometer, a method for processing zero adjustment of an inclinometer, that is, automatic zero adjustment of the inclinometer is desirable for controlling autonomous driving of a vehicle.

### SUMMARY

The effects obtainable from the present disclosure are not limited to the above-mentioned effects, and other effects not mentioned herein will be clearly understood by those skilled in the art through the following descriptions.

According to the present disclosure, a method performed by an apparatus associated with a moving object, the method may comprise, obtaining data about a velocity of the moving object, a global positioning system (GPS) altitude, a GPS latitude, a GPS longitude and a gradient associated with the moving object, determining, based on integrating the data, an integrated altitude value, determining, based on the integrated altitude value, an observed inclination offset value, determining, based on the observed inclination offset value, inclination offset estimation data, automatically adjusting, based on the inclination offset estimation data, an inclination offset value of an inclinometer associated with the moving object, outputting a signal indicating the adjusted inclination offset value, and controlling, based on the signal, autonomous driving of a vehicle.

The method may further comprise wherein the determining the integrated altitude value may comprise determining, based on a value indicating consistency of a GPS satisfying a threshold value, the integrated altitude value.

The method may further comprise determining the consistency of the GPS by determining whether at least one of an altitude change condition, a moving object velocity condition, or a stuck condition is satisfied.

The method, wherein the determining whether the altitude change condition is satisfied may comprise determining whether a change of the GPS altitude does not exceed a maximum altitude change per hour, wherein the maximum altitude change per hour is determined based on a feature of the moving object.

The method, wherein the determining whether the moving object velocity condition is satisfied may comprise determining whether the velocity of the moving object is equal to or lower than a threshold velocity that corresponds to a predetermined resolution limit, wherein the predetermined resolution limit represents a smallest change below which changes in data are considered too small to be detected without an error.

The method, wherein the determining whether the stuck condition is satisfied may comprise determining, based on the velocity of the moving object being considered, whether signals of the GPS latitude and the GPS longitude are updated at a predefined frequency or within a predefined time interval.

The method may further comprise determining a GPS state and whether gradient calculation is permitted, updating, based on the determining the GPS state and whether gradient calculation is permitted, the integration of the data, checking whether an integration time is an integer, wherein the integration time corresponds to a time period during which the integration of the data is performed, and storing, based on the integration time being the integer, the updated integration of the data in an integration log.

The method, wherein the determining the integrated altitude value may comprise, determining whether the integration time exceeds a maximum integration time or whether GPS is stuck, determining, based on the determining whether the integration time exceeds the maximum integration time or whether the GPS is stuck, whether to terminate the GPS, selecting, based on the determining whether to terminate the GPS, one of previously integrated altitude values before the GPS is stuck, and a currently integrated altitude value, and storing the selected one of the previously integrated altitude values and the currently integrated altitude value for the integration of the data.

The method, wherein the determining the inclination offset estimation data may comprise estimating the inclination offset estimation data by using recursive least squares (RLS) process with input parameters, and wherein the input parameters comprise, a GPS-based offset estimation covariance value, which is determined during driving of the moving object, wherein the GPS-based offset estimation covariance value indicates a level of uncertainty in GPS derived data, an inclination offset estimation count value indicating a number of times the RLS process updates inclination offset estimation, and a forgetting factor value indicating how much influence older data has compared to newer data in the RLS process.

The method, wherein the determining the observed inclination offset value may comprise restricting, based on a drift in the observed inclination offset value, a gradient estimation error to a predetermined value or below the predetermined value.

According to the present disclosure, an apparatus associated with a moving object, the apparatus may comprise, a processor, and a memory storing an inclinometer offset value and at least one instruction that, when executed by the processor, is configured to cause the apparatus to, obtain data about a velocity of the moving object, a global positioning system (GPS) altitude, a GPS latitude, a GPS longitude and a gradient associated with the moving object, determine, based on integrating the data, an integrated altitude value, determine, based on the integrated altitude value through a recursive least squares (RLS) process, an observed inclination offset value, determine, based on the observed inclination offset value, inclination offset estimation data, automatically adjust, based on the inclination offset estimation data, the inclinometer offset value of an inclinometer associated with the moving object, output a signal indicating the adjusted inclinometer offset value, and control, based on the signal, autonomous driving of a vehicle.

The apparatus, wherein the at least one instruction, when executed by the processor, is further configured to cause the apparatus to determine, based on a value indicating consistency of a GPS satisfying a threshold value, the integrated altitude value.

The apparatus, wherein the at least one instruction, when executed by the processor, is further configured to cause the apparatus to determine the consistency of the GPS by determining whether at least one of an altitude change condition, a moving object velocity condition, or a stuck condition is satisfied.

The apparatus, wherein the at least one instruction, when executed by the processor, is further configured to cause the apparatus to determine whether the altitude change condition is satisfied by determining whether a change of the GPS altitude does not exceed a maximum altitude change per hour, wherein the maximum altitude change per hour is determined based on a feature of the moving object.

The apparatus, wherein the at least one instruction, when executed by the processor, is further configured to cause the apparatus to determine whether the moving object velocity condition is satisfied by determining whether the velocity of the moving object is equal to or lower than a threshold velocity that corresponds to a predetermined resolution limit, wherein the predetermined resolution limit represents a smallest change below which changes in data are considered too small to be detected without an error.

The apparatus, wherein the at least one instruction, when executed by the processor, is further configured to cause the apparatus to determine whether the stuck condition is satisfied by determining, based on the velocity of the moving object being considered, whether signals of the GPS latitude and the GPS longitude are updated at a predefined frequency or within a predefined time interval.

The apparatus, wherein the at least one instruction, when executed by the processor, is further configured to cause the apparatus to, in order to determine the integrated altitude value, determine a GPS state and whether gradient calculation is permitted, update, based on a determination of the GPS and whether gradient calculation is permitted, the integration of the data, check whether an integration time is an integer, wherein the integration time corresponds to a time period during which the integration of the data is performed, and store, based on the integration time being the integer, the updated integration of the data in an integration log.

The apparatus, wherein the at least one instruction, when executed by the processor, is further configured to cause the apparatus to, in order to determine the integrated altitude value, determine whether the integration time exceeds a maximum integration time or whether GPS is stuck, determine, based on the determining whether the integration time exceeds the maximum integration time or whether the GPS is stuck, whether to terminate the GPS, select, based on a determination of whether to terminate the GPS, one of previously integrated altitude values before the GPS is stuck, and a currently integrated altitude value, and store the selected one of the previously integrated altitude values and the currently integrated altitude value for the integration of the data.

The apparatus, wherein the at least one instruction, when executed by the processor, is further configured to cause the apparatus to estimate the inclination offset estimation data by using the RLS process with input parameters in order to determine the inclination offset estimation data, and wherein the input parameters comprise, a GPS-based offset estimation covariance value, which is determined during driving of the moving object, wherein the GPS-based offset estimation covariance value indicates a level of uncertainty in GPS derived data, an inclination offset estimation count value indicating a number of times the RLS process updates inclination offset estimation, and a forgetting factor value indicating how much influence older data has compared to newer data in the RLS process.

The apparatus, wherein the at least one instruction, when executed by the processor, is further configured to cause the apparatus to restrict, based on a drift in the observed inclination offset value, a gradient estimation error to a predetermined value or below the predetermined value in order to determine the observed inclination offset value.

### BRIEF DESCRIPTION OF THE DRAWINGS

FIG. 1 shows an example of constituent modules of a moving object equipped with an automatic inclinometer zero adjustment device according to an example of the present disclosure.

FIG. 2 shows an example of a method for automatically adjusting the zero point of an inclinometer of a moving object according to another example of the present disclosure.

FIG. 3 shows an example of a process of estimating an offset if a zero point drift occurs to a location-based inclinometer according to an example of the present disclosure.

FIG. 4 shows an example of a process of determining consistency of a GPS according to an example of the present disclosure.

FIG. 5 shows an example of an integrator reset condition according to an example of the present disclosure.

FIG. 6 shows an example of calculating an altitude displacement according to an example of the present disclosure.

FIG. 7 shows an example of describing an integration end time of an integrator according to an example of the present disclosure.

FIG. 8A and FIG. 8B show an example of an operation flowchart of an integrator for calculating an integrated altitude value according to an example of the present disclosure.

FIG. 9 shows an example of a process of operating a recursive least squares (RLS) estimator according to an example of the present disclosure.

FIG. 10 shows an example of a location-based inclinometer offset drift estimation result according to an example of the present disclosure.

### DETAILED DESCRIPTION

Hereinafter, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of adjusting an inclination offset) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of adjusting an inclination offset) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of adjusting an inclination offset) described herein.

Minimum risk maneuver (MRM) operation(s) may also be controlled, for example, based on one or more features (e.g., features of adjusting an inclination offset) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle if a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of adjusting an inclination offset) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of adjusting an inclination offset) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

According to the present disclosure, an inclinometer used in a moving object may improve its accuracy and reliability by addressing errors caused by sensor drift and inconsistencies in GPS data. A method is introduced to automatically adjust the inclinometer's zero point using data from the moving object's velocity, GPS altitude, latitude, longitude, and gradient. By integrating this data and applying techniques like Recursive Least Squares (RLS) with parameters such as a forgetting factor value and a GPS-based offset estimation covariance value, the system dynamically may determine and adjust inclination offset values. It also may ensure the consistency of GPS data by checking conditions such as whether signals are updated at a sufficient frequency and whether velocity falls within detectable limits. This approach enhances the inclinometer's performance, enabling precise gradient measurements and more stable vehicle control, especially in real-time and challenging environments like tunnels or areas with poor GPS signals.

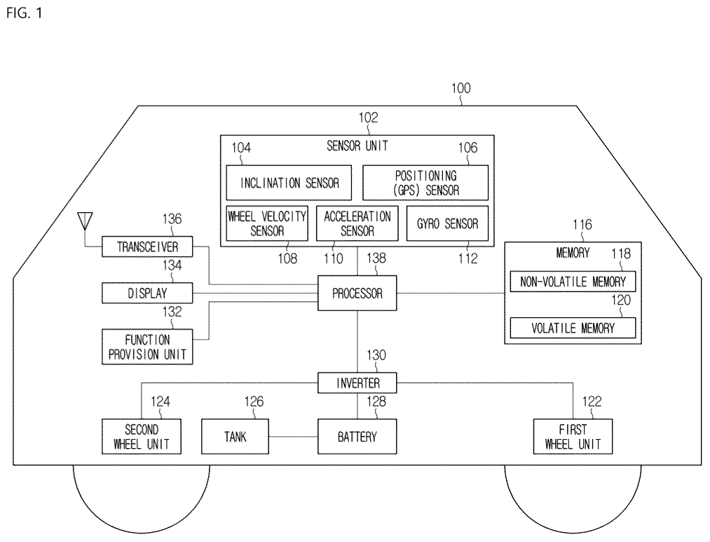

Hereinafter, referring to FIG. 1, an automatic inclinometer zero adjustment device of a moving object will be described according to an example of the present disclosure.

FIG. 1 shows an example of constituent modules of a moving object equipped with an automatic inclinometer zero adjustment device according to an example of the present disclosure.

A moving object 100 may be a moving object driven based on electric energy or fossil energy. Specifically, the moving object 100 may employ a direct-rechargeable electric battery or a gas-based fuel cell as an energy source. In the case of the fuel cell, the moving object 100 may use various types of gas capable of generating electric energy from the fuel cell, and for example, the gas may be hydrogen. However, without being limited thereto, various gases may be applicable. As another example, the moving object 100 may employ fossil fuels like gasoline and diesel as an energy source. In the present disclosure, the electric energy-based moving object 100 shown in FIG. 1 is described as an example, but an example according to the present disclosure may also be applied to moving object based on fossil energy.

The moving object 100 may refer to a device capable of moving. The moving object 100 may be a normal passenger vehicle or commercial vehicle, a mobile office, or a mobile hotel. The moving object 100 may be a four-wheel vehicle, for example, a sedan, a sports utility vehicle (SUV), and a pickup truck and may also be a vehicle with five or more wheels, for example, a bus, a lorry, a container truck, and a heavy vehicle. The moving object 100 may be implemented by manual driving or autonomous driving (either semi-autonomous or full-autonomous driving).

Meanwhile, the moving object 100 may perform communication with another device or another moving object. Herein, as an example, the moving object 100 may communicate with another vehicle based on cellular communication, wireless access in vehicular environment (WAVE) communication, dedicated short range communication (DSRC) or any other communication scheme. That is, LTE as a cellular communication network, a communication network such as 5G, a WiFi communication network and a WAVE communication network may be used. In addition, a short range communication network like DSRC in a moving object may be used and is not limited to the above-described example.

Specifically, the moving object 100 may include a sensor unit 102, a memory 116, a first wheel unit 122, a second wheel unit 124, a function provision unit 132, a display 134, a transceiver 136, and a processor 138.

The sensor unit 102 may be equipped with various types of sensor modules for sensing various states and situations inside and outside environments of the moving object. For example, the sensor unit 102 may include an inclination sensor 104 for measuring an angle of inclination of the moving object 100, a positioning sensor 106 for measuring a location of the moving object 100, a wheel velocity sensor 108 for measuring a velocity based on a wheel, an acceleration sensor 110 for detecting an acceleration of the moving object 100, and a gyro sensor 112 for detecting the posture and direction of the moving object 100. In addition, the sensor unit 102 may include an image sensor, which provides a visual image of the inside or outside of the moving object, a Lidar sensor, a radar sensor, and a distance sensor. The present disclosure mainly describes sensors referred to in describing an example but may further include a sensor for detecting various situations not listed herein.

The inclination sensor 104 may be equipped with modules for measuring an angle of inclination of the moving object 100 with respect to a ground surface, on which the moving object 100 stops or runs, and operator modules for calculating an angle of inclination. The inclination sensor 104 may calculate an angle of inclination with reference to an offset value of an inclinometer stored in the memory 116. For example, the offset value of the inclinometer may be a signal value corresponding to the zero point of the inclinometer. The offset value of the inclinometer may change according to maintenance or situation, and the inclination sensor 104 may calculate an angle of inclination by applying a changed offset value of the inclinometer. For example, a mechanic may connect a diagnostic tool capable of inputting a zero adjustment command to the processor 138 of the moving object 100, for example, to a VCU and use a zero point adjusted according to the command as an offset value of the inclinometer. In addition, according to the present disclosure, an offset value of the inclinometer, which has been changed with data based on the positioning sensor 106, may be used as a zero point. In the present disclosure, the inclination sensor 106 has an actually same meaning as an inclinometer, and the terms ‘inclination sensor’ and ‘inclinometer’ will be used interchangeably below.

The GPS 106 may measure two-dimensional locations and altitudes of the moving object 100 that stops or is running. A GPS sensor may measure the altitude, latitude and longitude of the moving object 100 based on information transmitted from a plurality of satellites. The GPS 106 is not limited to a GPS sensor but may consist of multiple sensors combining the GPS sensor and other sensors.

The wheel velocity sensor 108 may measure a wheel velocity based on a rotation of at least one wheel provided in the first and second wheel units 122 and 124. For example, in order to sense a wheel rotation, a wheel velocity sensor may be combined with a power transfer/drive/braking system such as a brake controller (electric braking system (EBS)) and/or automatic transmission control unit (TCU).

The acceleration sensor 110 may measure accelerations not only in a driving direction of the moving object 100 but also in a different direction from the driving direction. The gyro sensor 112 may function as a posture/bearing sensor for detecting a yaw or other postures of the moving object 100.

The memory 116 may store an application and various types of data for controlling the moving object 100 and at a request of the processor 138, load the application or read and record data. The memory 116 may include a non-volatile memory 118 and a volatile memory 120. The non-volatile memory 118 may constantly store and manage an application and data as long as it is not intentional, irrespective of start-up and power on/off. The volatile memory 120 may temporarily store data so that the data may be deleted if the moving object 100 is turned off and/or switched off.

In the present disclosure, the non-volatile memory 118 may include an application for correcting an offset value of an inclinometer based on data from the GPS 106 and at least one instruction, and the processor 138 may be configured to execute the application and the instruction stored in the memory 116. In addition, the non-volatile memory 118 may store and keep an offset value of the inclinometer used for the inclination sensor 104 in measuring an angle of inclination in replacement of an updated and changed value.

The moving object 100 may include an inverter 130 for transforming electric power of a battery 128 from a specific form to another form and reducing voltage and at least one or more of the first and second wheel units 122 and 124 that are being driven by receiving electric power from the inverter 130. The first and second wheel unit 122 and 124 may be configured to have a power transfer system apart from a wheel and a motor. If at least one of the first and second wheel units 122 and 124 is a drive wheel, a motor control module may be provided to control a motor for transmitting a drive force to wheels, a motor torque, a motor rotation direction, and braking.

A motor provided in a wheel unit may be driven by receiving electric power that is applied from the battery 128 via the inverter 130. In the case of a fuel cell, the battery 128 may include a hydrogen fuel cell equipped with a plurality of stacks that generate electric energy through interaction between hydrogen from a tank 106 and oxygen from outside. The battery 128 may provide the generated energy to various electrical devices for driving, lighting and air-conditioning of the moving object 100. The battery 128 may include a first battery for providing energy, for example, to drive wheels and high-power electric equipment and a second battery for providing energy to low-power electric equipment and charging the first battery. Herein, the second battery may be configured as a hydrogen fuel cell. The inverter 130 may convert a specific form of electric power of the battery 128, for example, alternating current to another form, for example, direct current and reduce a voltage.

The function provision unit 132 may have a functional module for various types of control for the moving object 100 and a passenger's convenience. The functional module may be activated according to a request of the processor 138 or a passenger, and a corresponding function may be implemented under the support of the processor 138 and the memory 116. For example, the moving object 100 may include an inclination measurement function, a weight estimation function, and a route guidance function based on map information transmitted from outside and data of the GPS 106. For example, the inclination measurement function may be a function necessary to notify an inclination of a road, on which the moving is running, in association with an embedded GPS and to optimize performance and fuel efficiency. The weight estimation function may be a function necessary for adaptive control of a power generation amount of a fuel cell, that is, to optimize fuel efficiency based on an estimated weight of the moving object 100. When the inclination estimation function and the weight estimation function are implemented, the function provision unit 132 may implement the functions by using an angle of inclination measured from the inclination sensor 104. Herein, the angle of inclination may be measured with reference to an offset value of an inclinometer, which is stored in the non-volatile memory 118 or is changed based on data of the GPS 106 while the moving object is running.

The display 134 may serve as a user interface. By the processor 138, the display 134 may display an operating state and a control state of the moving object 100, route/traffic information, a battery state, information on a remaining gas quantity, a content requested by a user, and the like to be output. The display 134 may be configured as a touch screen capable of sensing a user input and receive a request of the user indicated to the processor 138.

The transceiver 136 may support mutual communication with a moving object near a vehicle, an intelligence traffic service server or a road side base station, and a server or an edge device for providing various vehicle services.

The processor 138 may perform overall control of the moving object 100. The processor 138 may have at least one processing module, and each control-related function may be implemented in a single processing module or be implemented in a corresponding processing module among a plurality of modules. In relation to the present disclosure, the processor 138 may control the moving object 100 to correct an offset value of an inclinometer by using an application, an instruction and data stored in the memory 116.

Specifically, the processor 138 may obtain moving object velocity data while the moving object 100 is running, obtain data about a GPS altitude, a GPS latitude, a GPS longitude and a gradient through the GPS 106, and then calculate an integrated altitude value through an integrator based on the obtained data. Based on the obtained integrated altitude value, an observed slope offset value may be calculated. In addition, the processor 138 may calculate inclination offset estimation data based on the observed slope offset value. In addition, the processor 138 may perform automatic zero adjustment by correcting an offset value of the inclinometer stored in the moving object 100 based on the inclination offset estimation data.

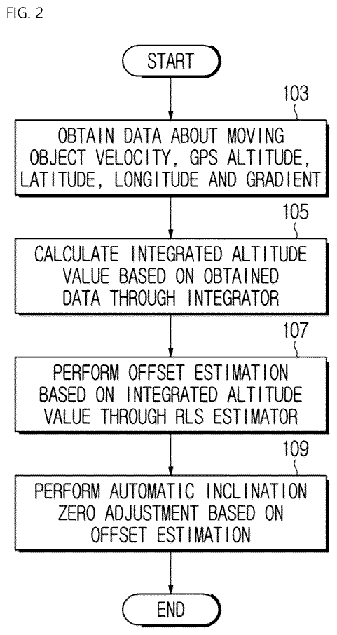

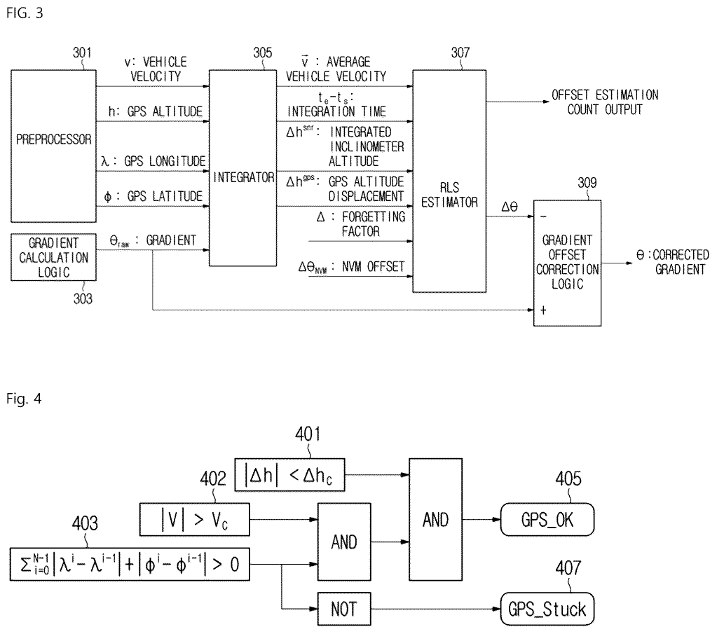

An automatic inclinometer zero adjustment device according to the present disclosure may include at least the inclination sensor 104, the GPS 106, the wheel velocity sensor 108, the non-volatile memory 118 and the processor 138 and may be a device configured to implement the processing of automatic zero adjustment of an inclination offset by the processor 138. The processing may be implemented in at least a part of the processor 138, for example, at least one processing module and at least a part of the memory 116, and the processor 138 and the memory 116 related to the processing may function as a VCU. The above-described processing of the processor 138 will be described in detail through FIG. 2, FIG. 3, and FIG. 4.

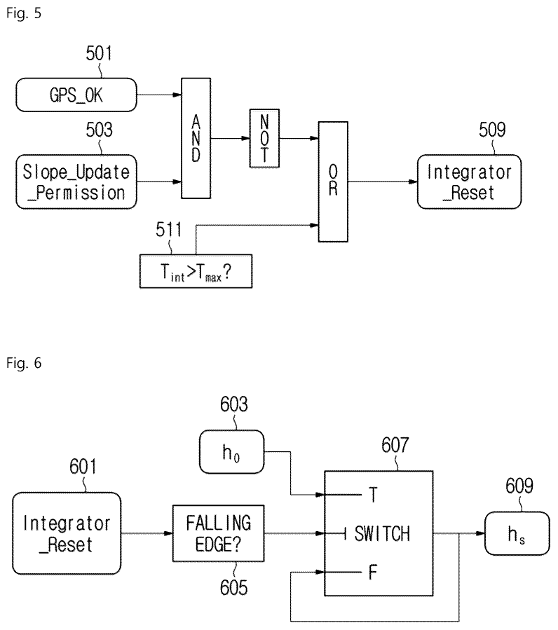

With reference to FIG. 2, FIG. 3, FIG. 4, FIG. 5, and FIG. 6, a method for automatically adjusting the zero point of an inclinometer of a moving object will be described in detail. FIG. 2 shows an example of a method for automatically adjusting the zero point of an inclinometer of a moving object according to another example of the present disclosure.

Referring to FIG. 2, a method for automatically adjusting the zero point of an inclinometer of a moving object according to the present disclosure may include obtaining data about a moving object velocity, a GPS altitude, a latitude, a longitude and a gradient (103), calculating an integrated altitude value based on the obtained data through an integrator (105), performing offset estimation based on the integrated altitude value through a RLS estimator (107), and performing automatic inclination zero adjustment based on the offset estimation (109). FIG. 3 shows an example of implementing the example according to FIG. 2.

First, according to step S103, the obtaining of the data about the moving object velocity, the GPS altitude, the latitude, the longitude and the gradient is performed by a preprocessor 301 of FIG. 3. For example, the moving object velocity v, the GPS altitude h, the latitude φ, and the longitude λ may be data that are preprocessed by the preprocessor 310. In addition, the gradient data θ_{raw} may be data that is calculated through a gradient calculation logic 303. However, the preprocessing is merely an example and is not an essential element.

Next, according to step S105, the calculating of the integrated altitude value based on the obtained data through the integrator is a process of deriving the integrated value by using the input data of step S103 by the integrator 305 of FIG. 3. Specifically, an average vehicle velocity v̅, an integration time t_{c}−tₛ (e.g., a time period during which the integration of the data is performed), an integrated altitude of inclinometer Δh^{snr}, and a GPS altitude displacement Δh^{gps} may be data calculated through the integrator 305.

Next, according to step S107, the performing of the offset estimation based on the integrated altitude value through the RLS estimator is a process of deriving an estimated offset count and a gradient offset Δθ by the RLS estimator 307 of FIG. 3 using the input data of step S105. Step S107 may be performed using not only the input data of step S105 but also a forgetting factor value Λ, which is a tuning element, and an offset Δθ_{NVM} stored in a non-volatile memory (NMV). In this regard, the forgetting factor value is information used to efficiently estimate a parameter that changes over time when the RLS estimator 307 executes a RLS algorithm, and any one of a variable forgetting factor value or a fixed forgetting factor value may be used according to a RLS algorithm design.

A forgetting factor value is a value used in the Recursive Least Squares (RLS) algorithm to control how much weight is given to new data compared to older data during calculations. The forgetting factor value may help the system adapt to changing conditions by gradually reducing the influence of outdated information. For example, recent GPS or velocity data might be prioritized to reflect the current state of the moving object, while older data becomes less relevant over time. For example, the forgetting factor value may range between 0 and 1: a value closer to 1 gives more weight to historical data, providing stability, while a value closer to 0 emphasizes recent data, allowing the system to respond quickly to changes. The forgetting factor value may ensure accurate and dynamic estimation of the inclination offset (e.g., in real-time, rapidly changing environments).

Next, according to step S109, the performing of the automatic inclination zero adjustment based on the offset estimation is a process of inputting a gradient offset, which is obtained by the RLS estimator 307 of FIG. 3 at step S107, into a gradient offset correction logic 309 and calculating a corrected gradient value θ.

Prior to step S105, a step of determining consistency of the GPS 106 is needed, and the integrator is operated in response to the consistency being satisfied. Referring to FIG. 4, the step for the consistency of the GPS 106 will be described in detail.

First, in the step of determining the consistency of the GPS based on a location, as a GPS signal is a signal that slowly changes, when previous numbers are expressed, a signal history changing at a relatively slow cycle is marked with a superscript, and a signal history changing at a fast cycle is marked with a subscript. Accordingly, each index of each signal may be expressed as follows.

$$\begin{matrix}t ( {s}_{i} ) - t ( {s}_{i - 1} ) = Δ t \\ t ( {s}^{i} ) - t ( {s}^{i - 1} ) = Δ T = Cnt \cdot Δ t\end{matrix} \qquad [ Equation 1 ]$$

Here, t(x) is a time when a signal x is measured, and Δt is a cycle time of a controller.

In Equation 1 above, for example, if Δt of a VCU is set to 0.01 s and Cnt is set to 100, the result is ΔT=1 s. s⁰ and s₀ of a current time are always the same.

Referring to FIG. 4, the GPS consistency determination according to the present disclosure depends on whether an altitude change condition 401, a moving object velocity condition 401 and a stuck condition 403 are satisfied. To determine the consistency, the processor 138 may obtain a parameter related to whether each of the conditions 401, 402 and 403 is satisfied, that is, detailed requirements for determining the consistency and calculate a related equation to generate a result value.

Before determining whether each of the detailed requirements for determining GPS consistency is satisfied, a GPS-based location estimation needs a predetermined convergence time. Before convergence, a GPS sensor may transmit an initial value (also referred to as invalid value). As an example according to the present disclosure assumes that a GPS sensor transmits a GPS latitude and longitude coordinate (0, 0) before location convergence, in the case of a ground moving object, the coordinate (0, 0) corresponds to international waters on the equator, which has no likelihood of confusion with an actual coordinate.

In addition, an initial value transmitted before convergence may be different according to a type of the moving object and a sensor.

It is necessary to determine whether the altitude change condition 401 for determining the consistency of the GPS according to the present disclosure is satisfied, because a maximum hourly change is predetermined according to a physical feature of a moving object. As latitude, longitude and altitude values change drastically immediately after GPS convergence, if a measured change of altitude Δh exceeds a predefined maximum hourly altitude change, it may be determined that there is no GPS consistency. If the GPS does not satisfy the altitude change condition, in this situation, the GPS may diverge, the GPS enters a shadow area and then enters a service area again and converges, or the GPS converges on an initial location of initial driving.

If an altitude change (Δh=h₋₁−h₀) of the moving object 100 measured from the GPS 106 does not exceed a predetermined maximum hourly altitude change (|Δh|) according to a feature of the moving object, a parameter and an equation related to the altitude change condition 401 determine that the consistency is satisfied. For example, the equation may be Equation 2 below.

$$\vert Δ h \vert < Δ {h}_{c} \qquad [ Equation 2 ]$$

For example, when an altitude signal cycle is 0.2 second, if a consistency determination criterion Δh_{c} is set to 2 m and a highest moving object velocity vₘₐₓ is defined as 110 kph based on a commercial car, a gradient condition for not satisfying the altitude consistency condition may be derived in Equation 3 below.

$$\begin{matrix}{v}_{ert} = v sin ( θ ) \geq \frac{2}{0.2} \frac{m}{s} = 10 \frac{m}{s} \\ θ \geq asin ( \frac{10}{110} \cdot 3.6 ) = 0.333 rad \\ θ \geq 34.63 \%\end{matrix} \qquad [ Equation 3 ]$$

That is, when the moving object is driven at a velocity of 110 kph and on a gradient of about 34.6%, the altitude consistency condition may not be satisfied under the normal GPS condition, but this situation hardly occurs as a real service condition, and even if acceleration offset correction is performed with the exclusion of such a situation, the technical problems of the present disclosure may be achieved without difficulty.

Meanwhile, according to an example of the present disclosure, if the moving object is a flying object, a rapid vertical movement may occur so that the altitude change-based consistency determination condition may be modified or excluded.

In addition, to determine the consistency of the GPS 106, the processor 138 may determine whether the moving object velocity condition 402 and the stuck condition 403 are satisfied.

As for the moving object velocity condition 402, if the moving object velocity is equal to or lower than an error caused by a predetermined resolution limit, it may be determined that the consistency is satisfied. A predetermined resolution limit refers to a smallest measurable change in data, such as velocity or position, that a system (e.g., GPS) may reliably detect without introducing errors. This limit may be set based on the precision and accuracy of the sensors and/or algorithms, like GPS systems, used to gather data. For instance, if changes in velocity or position are smaller than the resolution limit, they may be indistinguishable from noise or minor inaccuracies in the sensors. This ensures the system only processes meaningful data while ignoring insignificant variations, providing a reliable basis for detecting movement or determining data consistency.

When the moving object velocity condition 402 according to the present disclosure is calculated, a location resolution is different according to a sensor, and this analysis may assume that a signal with a resolution of 1 arc second= 1/3600 degree=about 30.87 m for both latitude and longitude is received.

If a moving object moves at a low velocity that is equal to or greater than an error caused by a predetermined resolution limit, an error effect becomes greater due to a limited location resolution, and thus if a moving object velocity is equal to or greater than the velocity, inclinometer offset correction may be performed.

For example, at the moving object velocity (v_{c}), which is a criterion, or above, a moving object may be considered moving almost in a straight line. According to an example of the present disclosure, a maximum \sqrt{2}-arcsec movement is required for both GPS latitude and longitude to change by 1 tick (one arcsecond) or more. That is, if (v≥v_{c}), that is, under a condition for correcting an acceleration offset, latitude and longitude coordinates may have same values for as long as 4 cycles. Accordingly, if latitude and longitude coordinates are stuck for 6 cycles including a predetermined margin of the curvature and gradient of a road, integration for acceleration offset correction is suspended.

As for the stuck condition 403, when the moving object velocity condition is considered, if the latitude and longitude signals of the GPS are normally updated (e.g., updated at a predefined frequency or within a predefined time interval, etc.), it is determined that the consistency is satisfied. For example, when no GPS signal is available in a tunnel or underground, a latitude or longitude value may not be updated but be stuck. In this case, after a moving object passes through the tunnel, the latitude or longitude value is updated stepwise.

As an inclinometer is still operating in such a stuck situation, it is not appropriate to include a stuck time in cumulative comparison. Accordingly, for example, if a stuck situation occurs, this problem may be overcome by excluding data of the last 6 seconds from integration.

As an example, in case 6 seconds is set as a criterion for determining a stuck situation, if a moving object passes a tunnel with a length of 55 m or less, there is a possibility of malfunction. However, if an RLS estimation to be described below is used, an offset is estimated using not only one estimate but a plurality of estimates, which may minimize malfunction in a particular situation.

Referring to FIG. 4 again, if all the consistency determination conditions 401, 402 and 403 are satisfied, a GPS consistency determination signal (GPS_OK) 405 is generated, and the processor 138 may calculate the integrated altitude value through an integrator based on moving object velocity data and data about a GPS altitude, GPS latitude and longitude and gradient, when the GPS consistency determination signal is generated.

On the other hand, if at least one of the consistency determination conditions is not satisfied, the GPS consistency determination signal (GPS_OK) 405 is not generated, and the processor 138 may discard obtained moving object velocity data and data about a GPS altitude, GPS latitude and longitude and gradient, which are based on the GPS 106, and perform the above-described step S105 by using information that is subsequently obtained.

In addition, if, among the consistency determination conditions, the stuck condition 403 is not satisfied, a GPS stuck signal (GPS_Stuck) 407 is generated, and the processor 138 does not use information on a GPS altitude, a latitude and a longitude until the GPS is released from the stuck situation, so that it is possible to reduce an error of inclinometer zero adjustment. This will be described in detail below.

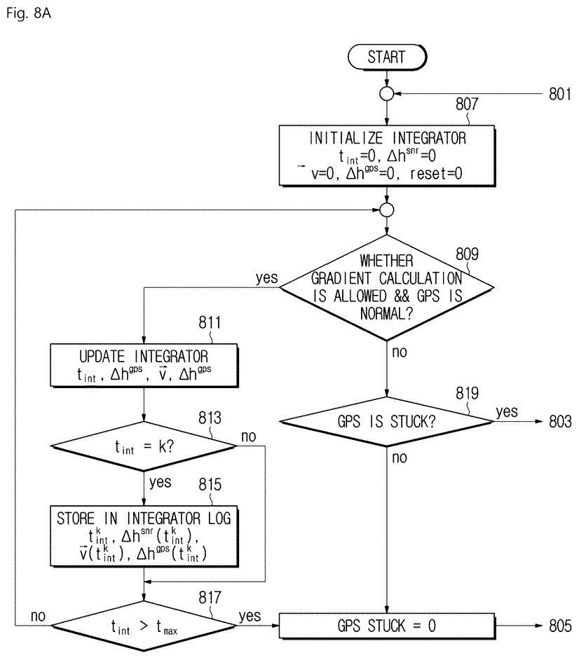

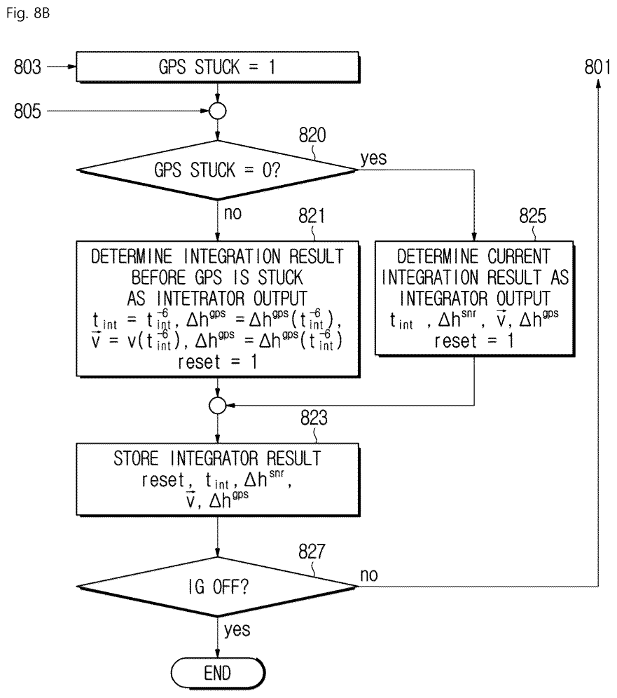

Hereinafter, an operational sequence of an integrator will be described with reference to FIG. 8A and FIG. 8B. FIG. 8A and FIG. 8B show an example of an operation flowchart of an integrator for calculating an integrated altitude value according to an example of the present disclosure.

The integrator may receive initialized data as input (807) and then determine whether gradient calculation is permitted and a GPS state (809).

In this regard, the calculating of the integrated altitude value through the integrator (105) needs resetting the integrator by receiving a reset signal according to an integrator reset condition.

An integrator reset condition necessary for initializing an integrator, which is required for an operational sequence of the integrator, will be described with reference to FIG. 5. FIG. 5 shows an example of an integrator reset condition according to an example of the present disclosure.

A conventional slope estimation logic has an update prohibition logic in consideration of a pitching motion of a vehicle. The integrator reset signal (Integrator_Reset) 509 may be designed to refer to both the above-described GPS consistency determination signal (GPS_OK) 501 and a slope update permission signal (Slope_Update_Permission) 503 and to permit integration of the integrator only if both of the two signals are true and to reset the integrator only if at least one of the two signals is true.

In addition, if an integration time (tᵢₙₜ) (e.g., a time period during which the integration of the data is performed) exceeds a maximum integration time (tₘₐₓ (511), the integrator reset signal (Integrator Reset) 509 is generated and the integrator is reset. For example, if the maximum integration time is short and a resolution of an observed altitude is restricted to about 1 m, there may be many offset estimation errors, but offset estimation itself may take a shorter time. On the other hand, if the maximum integration time is long, a lot of data may be obtained so that offset estimation may be performed relatively accurately, but offset estimation itself may take a longer time. Accordingly, in consideration of what is described above, it is necessary to determine a suitable maximum integration time (tₘₐₓ to be applied to an integrator according to a system purpose.

In addition, in order to perform the calculating of the integrated altitude value (105) according to FIG. 8A and FIG. 8B, the integrator may have to calculate an altitude displacement.

Referring to FIG. 6, a process of calculating an altitude displacement will be described. FIG. 6 shows an example of calculating an altitude displacement according to an example of the present disclosure.

In order to measure an altitude displacement, it is necessary to remember an altitude at a falling-edge 605 of the integrator reset signal 601, that is, a time (tₛ) of shift from 1 to 0 (1->0). Accordingly, a standard altitude (hₛ) 609 is a measured altitude (h₀) 603 at current time. After a switch 607 of an altitude displacement calculation logic determines whether the falling-edge 605 of a reset signal is sensed, if the falling-edge is sensed, based on hₛ=h₀, hₛ stored in a controller is updated, and otherwise, a past-stored hₛ value remains the same.

Specifically, when a flowchart of operating an integrator is described with reference to FIG. 8A and FIG. 8B, the integrator may receive initialized data as input (tᵢₙₜ=0, Δh^{snr}=0, v̅=0, Δh^{gps}=0, reset=0) (807) and then determine whether gradient calculation is permitted and a GPS state (809). In this regard, in step S809, whether the above-described GPS consistency determination signal (GPS_OK) 405 is present may be determined.

That is, if gradient calculation is permitted and the GPS operates normally (e.g., updated at a predefined frequency or within a predefined time interval, etc.), integrator data tᵢₙₜ, h^{snr}, v̅, Δh^{gps} may be updated (811), and if the integration time tᵢₙₜ is an integer k=0, 1, 2 . . . (813), the updated integrator data may be stored in an integrator log (815). Herein, the integration time may be assumed to be an integer k. Accordingly, values stored in the integrator log may be

$${t}_{int}^{k} , Δ {h}^{s n r} ( {t}_{int}^{k} ) , and \overline{v} ( {t}_{int}^{k} ) , Δ {h}^{gps} ( {t}_{int}^{k} )$$

respectively.

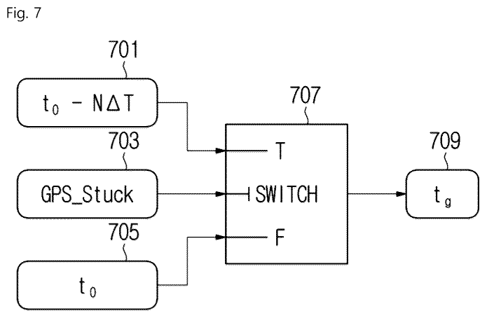

Meanwhile, in the calculating of the integrated altitude value through the integrator (105), if a latitude or longitude-stuck situation occurs if the GPS state is determined, an integration end time of the integrator may be determined with reference to FIG. 7. FIG. 7 shows an example of describing an integration end time of an integrator according to an example of the present disclosure.

Specifically, in a controller (e.g., VCU), an integrated value of a current time to 705 and an integrated value of a past time t₀−NΔT 701 may always be memorized. For example, if an integrator reset trigger is transmitted and the trigger is generated due to a GPS stuck situation (GPS_Stuck) 703, an integrated value between a time tₛ and the time t₀−NΔT may be transmitted to an estimator through a switch 707 of the estimator. Herein, as Δh^{gps} is a difference between a standard altitude and a current altitude, strictly speaking, integration is not performed, but for convenience, it may be expressed as delivery from the integrator to the estimator.

An integration end time to 709 of the integrator may be calculated through a value delivered from the switch 707 of the estimator. By reflecting the integration end time t_{c}, an integrated altitude value may be calculated by Equation 4 below.

$$\begin{matrix}Δ {h}^{s n r} = {\int }_{{t}_{s}}^{{t}_{e}} v \cdot sin ( {θ}_{r a w} ) d t \\ {t}_{i n t} = {t}_{e} - {t}_{s} = {\int }_{{t}_{s}}^{{t}_{e}} 1 d t \\ \overline{v} = \frac{1}{{t}_{e} - {t}_{s} + ϵ} {\int }_{{t}_{s}}^{{t}_{e}} v \cdot dt \\ Δ {h}^{gps} = {h}_{e} - {h}_{s}\end{matrix} \qquad [ Equation 4 ]$$

Here, ϵ in calculating an average velocity by Equation 4 may be set to 0.01 because it is a small value to prevent the divide by zero error. As an error caused by an attempt of a mathematically undefined operation, the divide by zero error may mean a case where a result of division is not defined since a number is divided by zero as a dividing number.

Hereinafter, a process of operating an integrator will be described with reference to FIG. 8A and FIG. 8B. First, if the integration time exceeds a maximum integration time (tᵢₙₜ>tₘₐₓ) (817), the GPS stuck signal (GPS_Stuck) may be set to 0. On the other hand, if the integration time does not exceed the maximum integration time, whether gradient calculation is permitted and a GPS state may be determined (809).

In addition, whether the GPS is stuck is determined (819), and if it is determined that the GPS is stuck, the GPS stuck signal (GPS_Stuck) may be set to 1, and on the other hand, if it is determined that the GPS is not stuck, the GPS stuck signal (GPS_Stuck) may be set to 0.

After the above process, it may be determined whether the GPS stuck signal (GPS_Stuck) is 0 or 1 (820), and if the GPS stuck signal (GPS_Stuck) is 0, a current integration result tᵢₙₜ, Δh^{snr}, v̅, Δh^{gps} (reset=1) may be determined as an integrator output (825). On the other hand, if the GPS stuck signal (GPS_Stuck) is 1, an integration result before the GPS is stuck

$$( {t}_{int} = {t}_{int}^{- 6} , Δ {h}^{snr} = Δ {h}^{snr} ( {t}_{int}^{- 6} ) , \overline{v} = \overline{v} ( {t}_{int}^{- 6} ) , Δ {h}^{gps} = Δ {h}^{gps} ( {t}_{int}^{- 6} ) , reset = 1 )$$

may be determined as an integrator output (821). tᵢₙₜ⁻⁶ may mean a value that is calculated 6 times before within an integrator log buffer. During integration, reset=0 or reset=1.

In addition, as another example, without performing step S820, step S825 and step S821 may be performed. The integrator output result (reset, tᵢₙₜ, Δh^{snr}, v̅, Δh^{gps}) may be stored in the integrator (823).

After the integrator result is stored, whether the integrator finishes operating is determined according to whether the integrator is on or off (827). If the integrator is on, the operation of the integrator may go back to the beginning so that the integrator may operate from the beginning (801). If the integrator is off, the flowchart of operating the integrator may end immediately. In this regard, in principle, the integrator is constantly operated while the moving object is running, but the present disclosure is not necessarily limited thereto.

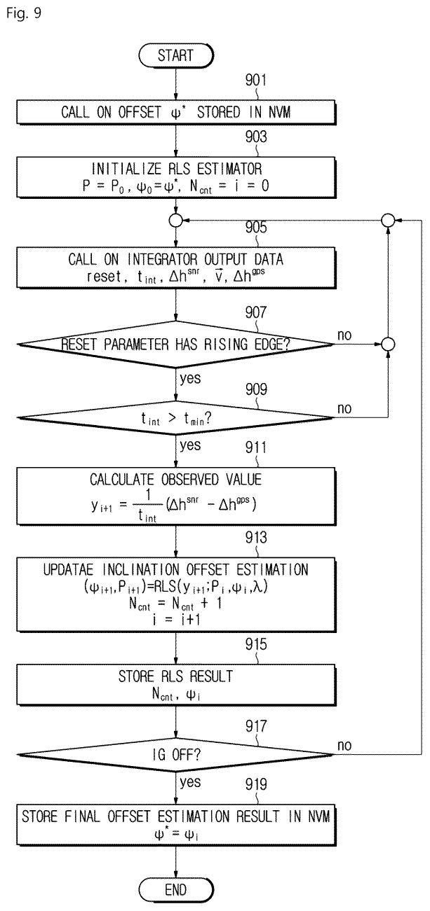

Referring FIG. 9, the above-described step S109 will be described in detail. FIG. 9 shows an example of a process of operating an RLS estimator.

The calculating of the inclination offset estimation data according to the present disclosure (109) may read an inclinometer offset value stored in a non-volatile memory (901) and perform initialization for data of an RLS estimator like the calculating of the integrated altitude value through the integrator (903).

In the RLS estimator exemplified in FIG. 9, P₀ may be an initial covariance (e.g., GPS-based offset estimation covariance value) and be a tuning parameter that is set according to a requirement for RLS estimation, a state of the moving object 100 and a surrounding environment. ψ₀ may be an initialized inclinometer offset value, and N_{cnt} may be a parameter representing a number of estimations for an inclinometer offset. GPS-based offset estimation covariance value may represent a measure of uncertainty or variability in the GPS data used for estimating an inclinometer's offset. GPS-based offset estimation covariance value may quantify how reliable the GPS-derived measurements (such as latitude, longitude, and altitude) are during the vehicle's movement. This covariance value is used in calculations, such as those performed by the Recursive Least Squares (RLS) algorithm, to adjust the weight or influence of the GPS data on the offset estimation process. For example, if the covariance value is low, it may mean the GPS data is more stable and trustworthy, while higher covariance value may indicate greater variability, prompting the system to treat the data with caution.

After input data of the RLS estimator is initialized, a reset parameter calculated through the integrator, an integration time tᵢₙₜ, an inclinometer integration altitude Δh^{snr}, an average velocity of the moving object v̅, and GPS altitude displacement data Δh^{gps} are received as inputs (905). As for an operating method of a signal of the reset parameter, if the reset signal shifts from LOW to HIGH, a term “rising edge” is used. That is, if a rising edge occurs, the data are reset (907).

According to the determination, if the rising edge occurs, it may be determined whether an integration time is equal to or greater than a minimum integration time (909), and if so, an observed value of an RLS operator may be calculated (911).

When the observed value of the RLS operator is calculated, it may be obtained using small angle approximation through Equation 5 below.

$$θ = {θ}_{r a w} + Δθ {v}_{h}^{gps} = v \cdot sin ( θ ) ; {v}_{h}^{snr} = v \cdot sin ( {θ}_{r a w} ) ; {v}_{h}^{snr} - {v}_{h}^{gps} ≅ v \cdot ( {θ}_{raw} - θ ) \frac{1}{{t}_{e} - {t}_{s}} {\int }_{{t}_{s}}^{{t}_{e}} {v}_{h}^{snr} - {v}_{h}^{gps} dt = \frac{1}{{t}_{e} - {t}_{s}} ( Δ {h}^{snr} - Δ {h}^{gps} ) = \frac{\overline{v}}{{t}_{e} - {t}_{s}} {\int }_{{t}_{s}}^{{t}_{e}} {θ}_{raw} - θ d t = \overline{v} \cdot Δθ ; \qquad [ Equation 5 ]$$

Herein, Equation 5 may be put into a form for using the conventional RLS with forgetting (a technique of estimating a dynamic model of a system by using the recurrence least squares method). A state estimation update of the estimator may be performed only if an integrator of a vehicle is on and tᵢₙₜ>tₘᵢₙ.

Herein, an observed value

$$y = \frac{1}{{t}_{int}} ( Δ {h}^{snr} - Δ {h}^{gps} ) , Φ = \overline{v} ,$$

and an offset x=Δθ are defined (913).

In addition, the estimation may be performed by adding a forgetting factor value λ. In the estimation, an inclination offset estimation count value (N_{cnt}), which is used as the input factor, may be determined according to a value of the forgetting factor value. Specifically, a count value, which is used as an input factor, may be determined by selecting at least one of current and past count values based on a value of the forgetting factor value. An inclination offset estimation count value may refer to a number of times a system updates or refines its estimate of the inclinometer's offset during operation. This count may track the iterations of the Recursive Least Squares (RLS) algorithm, which continuously processes new data to improve the accuracy of the inclination offset estimation. Each update may incorporate information such as velocity, GPS-derived measurements, and gradient data. By keeping track of the estimation count value, the system may ensure that it has sufficient iterations to produce a reliable and stable offset value.

For example, the forgetting factor value λ is a tuning element and may be set according to a requirement of RLS estimation, and for example, the forgetting factor value may be fixed to 0.95. Meanwhile, the integration time tₘᵢₙ is a tuning element and may be set to 30 seconds. If the integration time is equal to or shorter than a preset time interval, inaccurate offset estimation may be performed according to an altitude resolution.

Next, the processor 138 may update inclination offset estimation data based on an observed value of the RLS operator (913). The inclination offset estimation data may be obtained by a predetermined estimation logic.

Next, when the inclination offset estimation data ((ψᵢ₊₁, Pᵢ₊₁)=RLS(yᵢ₊₁; Pᵢ, ψᵢ, λ) N_{cnt}=N_{cnt}+1, i=i+1) are updated, a data result may be stored in the RLS operator, and final result values (N_{cnt}, ψᵢ) of the offset estimation data are stored in the non-volatile memory (NVW) (915).

Finally, depending on whether the integrator is on/off, it may be determined whether the flowchart of RLS operation is to be terminated (917). If the integrator is on, the process may return to before step S905, which is an initial step of the RLS operation flowchart. If the integrator is off, a final offset estimation result ψ*=ψᵢ may be stored in NVM (919), and the RLS operation may be terminated.

According to the present disclosure, by using information obtained from the GPS 106 provided in the moving object 100 with no additional module being installed, zero adjustment required in the inclinometer 104 of the moving object 100 may be automatically performed. Automatic inclinometer zero adjustment may prevent an inclination measurement error and a weight estimation error that are caused by zero point drift of an inclinometer.

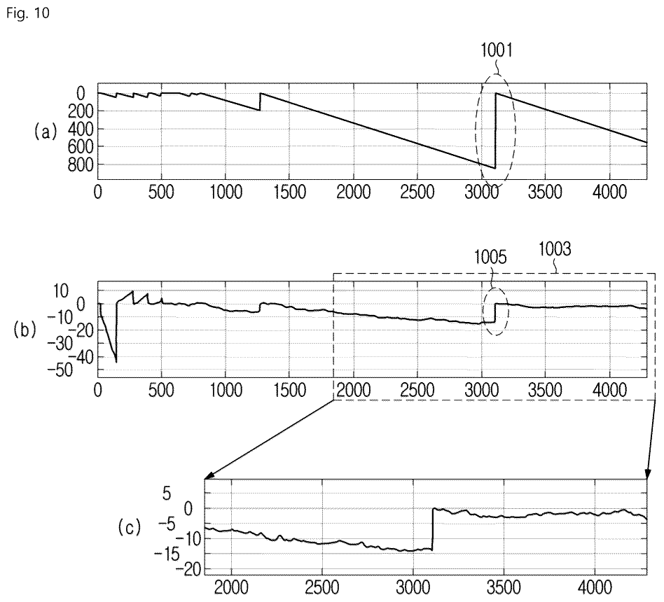

FIG. 10 shows an example of a location-based inclinometer offset drift estimation result according to an example of the present disclosure. Referring to FIG. 10, offset correction based on the inclinometer offset drift estimation result will be described.

In FIG. 10, (a) is an altitude displacement graph with no correction of zero point drift, (b) is an altitude displacement graph with correction of zero point drift, and (c) is an enlarged graph of the altitude displacement prediction error in (b).

For example, an initial inclinometer offset of integration is a value calculated at a previous driving cycle and may be assumed to be −0.02. When the driving cycle ends, a total inclinometer offset may be stored in a controller NMV, and this may become an initial inclinometer offset value of a next driving cycle.

According to the present disclosure, if offset correction is not performed, if comparison is made about every 1000 m, an altitude displacement prediction error may be removed by about 99.6% (1001). According to the present disclosure, even if an offset change occurs exceeding a preset reference value, offset correction may be possible according to the present disclosure (1003). According to an example of the present disclosure, after zero-point offset drift is corrected, an altitude displacement prediction error of driving for about 1300 s may be up to about 4 m (1005).

That is, when there is a drift, if the present disclosure is applied to restrict a gradient estimation error to a preset reference value or below, weight estimation and weight-adaptive vehicle control may be implemented within a life time.

The present disclosure is technically directed to providing a method and device for automatically adjusting the zero point of an inclinometer of a moving object by using GPS altitudes, GPS latitudes and GPS longitudes.

The technical problems solved by the present disclosure are not limited to the above technical problems and other technical problems which are not described herein will be clearly understood by a person having ordinary skill in the technical field, to which the present disclosure belongs, from the following description.

According to the present disclosure, a method is provided for automatic zero adjustment of an inclinometer of a moving object. The method may comprising: obtaining data about a moving object velocity, a GPS altitude, a GPS latitude, a GPS longitude and a gradient, calculating an integrated altitude value based on the obtained data through an integrator, calculating an observed inclination offset value based on the integrated altitude value, calculating inclination offset estimation data based on the observed inclination offset value and performing automatic zero adjustment by correcting an inclination offset based on the offset estimation data.

According to an example of the method of the present disclosure, the method, further comprising determining consistency of a GPS before the calculating of the integrated altitude value, wherein the calculating of the integrated altitude value is performed in response to satisfaction of the consistency.

According to an example of the method of the present disclosure, the method, wherein the determining of the consistency of the GPS determines whether an altitude change condition, a moving object velocity condition and a stuck condition are satisfied.

According to an example of the method of the present disclosure, the method, wherein, in the determining of the consistency of the GPS, the altitude change condition determines the satisfaction of the consistency, if a change of the GPS altitude does not exceed a maximum altitude change per hour that is determined according to a feature of the moving object.

According to an example of the method of the present disclosure, the method, wherein, in the determining of the consistency of the GPS, the moving object velocity condition determines the satisfaction of the consistency, if the moving object velocity is equal to or lower than an error caused by a predetermined resolution limit.

According to an example of the method of the present disclosure, the method, wherein, in the determining of the consistency of the GPS, based on the moving object velocity being considered, the stuck condition determines the satisfaction of the consistency, if signals of the GPS latitude and the GPS longitude are normally updated (e.g., updated at a predefined frequency or within a predefined time interval, etc.).

According to an example of the method of the present disclosure, the method, further comprising: calculating the integrated altitude value, determining whether gradient calculation is permitted and a GPS state, updating the integrator with the obtained data according to a result of the determining; and checking whether an integration time is an integer and storing the updated data in an integrator log.

According to an example of the method of the present disclosure, the method, wherein the calculating of the integrated altitude value further comprises: determining whether the integration time exceeds a maximum integration time or whether the GPS is stuck, determining whether to terminate the GPS according to a result of the determining and selecting, according to whether to terminate the GPS, any one of an integration result before the GPS is stuck and a current integration result and storing the selected result in the integrator.

According to an example of the method of the present disclosure, the method, wherein the calculating of the inclination offset estimation data estimates the inclination offset estimation data by using recursive least squares (RLS), and wherein the estimating according the RLS comprises adding a GPS-based offset estimation covariance, which is calculated during driving of the moving object, an inclination offset estimation count, and a forgetting factor value as parameters.

According to an example of the method of the present disclosure, the method, wherein the calculating of the observed inclination offset value restricts a gradient estimation error to a predetermined value or below, if there is a drift in the observed inclination offset value.

According to another example of the present disclosure, a device is provided for automatic zero adjustment of an inclinometer of a moving object. The device my comprising: a memory configured to store at least one instruction and an inclinometer offset value and a processor configured to execute the at least one instruction stored in the memory, wherein the processor is further configured to obtain data about a moving object velocity, a GPS altitude, a latitude, a longitude and a gradient, calculate an integrated altitude value based on the obtained data through an integrator, calculate an observed inclination offset value based on the integrated altitude value through a recursive least squares (RLS) estimator, calculate inclination offset estimation data based on the observed inclination offset value, and perform automatic zero adjustment by correcting an inclinometer offset based on the offset estimation data.

According to an example of the device of the present disclosure, the device, wherein the processor is further configured to determine consistency of a GPS before calculating the integrated altitude value, and wherein the calculating of the integrated altitude value is performed in response to satisfaction of the consistency.

According to an example of the device of the present disclosure, the device, wherein the processor is further configured to determine, in order to determine the consistency of the GPS, whether at least one or more of an altitude change condition, a moving object velocity condition and a stuck condition are satisfied.

According to an example of the device of the present disclosure, the device, wherein the altitude change condition determines the satisfaction of the consistency, if a change of the GPS altitude does not exceed a maximum altitude change per hour that is determined according to a feature of the moving object.

According to an example of the device of the present disclosure, the device, wherein the moving object velocity condition determines the satisfaction of the consistency, if the moving object velocity is equal to or lower than an error caused by a predetermined resolution limit.

According to an example of the device of the present disclosure, the device, wherein based on the moving object velocity being considered, the stuck condition determines the satisfaction of the consistency, if signals of the GPS latitude and the GPS longitude are normally updated (e.g., updated at a predefined frequency or within a predefined time interval, etc.).

According to an example of the device of the present disclosure, the device, further comprising: wherein the processor is further configured to: in order to calculate the integrated altitude value, determine whether gradient calculation is permitted and a GPS state, update the integrator with the obtained data according to a result of the determining, and check whether an integration time is an integer and store the updated data in an integrator log.

According to an example of the device of the present disclosure, the device, wherein the processor is further configured to: in order to calculate the integrated altitude value, determine whether the integration time exceeds a maximum integration time or whether the GPS is stuck, determine whether to terminate the GPS according to a result of the determining, and select, according to whether to terminate the GPS, any one of an integration result before the GPS is stuck and a current integration result and store the selected result in the integrator.

According to an example of the device of the present disclosure, the device, wherein the processor is further configured to estimate the inclination offset estimation data by using recursive least squares (RLS) in order to calculate the inclination offset estimation data, and wherein the estimating according the RLS adds a GPS-based offset estimation covariance, which is calculated during driving of the moving object, an inclination offset estimation count, and a forgetting factor value as parameters.

According to an example of the device of the present disclosure, the device, wherein the processor is further configured to, if there is a drift in the observed inclination offset value, restrict a gradient estimation error to a predetermined value or below in order to calculate the observed inclination offset value.

According to the present disclosure, it is possible to provide a method and device for automatically adjusting the zero point of an inclinometer by using GPS altitudes, GPS latitudes and GPS longitudes.

Specifically, zero adjustment required by an inclinometer may be automatically performed by using information obtained from a GPS provided in a moving object without a separate sensor being installed.

According to the present disclosure, automatic zero adjustment may prevent an inclination measurement error and a weight estimation error that are caused by zero point drift of an inclinometer.

According to the present disclosure, even if an aging inclinometer has changed its reaction feature or zero adjustment is missed during a maintenance work after the inclinometer or a controller (e.g., vehicle control unit (VCU)) of the inclinometer is replaced, an inclination offset, that is, the zero point may be automatically adjusted by using velocities of a running moving object and GPS information.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative examples of the present disclosure. Examples or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed:

1. A method performed by an apparatus associated with a moving object, the method comprising:
obtaining data about a velocity of the moving object, a global positioning system (GPS) altitude, a GPS latitude, a GPS longitude and a gradient associated with the moving object;
determining, based on integrating the data, an integrated altitude value;
determining, based on the integrated altitude value, an observed inclination offset value;
determining, based on the observed inclination offset value, inclination offset estimation data;
automatically adjusting, based on the inclination offset estimation data, an inclination offset value of an inclinometer associated with the moving object; and
outputting a signal indicating the adjusted inclination offset value.

2. The method of claim 1, further comprising wherein the determining the integrated altitude value comprises determining, based on a value indicating consistency of a GPS satisfying a threshold value, the integrated altitude value.

3. The method of claim 2, further comprising determining the consistency of the GPS by determining whether at least one of an altitude change condition, a moving object velocity condition, or a stuck condition is satisfied.

4. The method of claim 3, wherein the determining whether the altitude change condition is satisfied comprises determining whether a change of the GPS altitude does not exceed a maximum altitude change per hour, wherein the maximum altitude change per hour is determined based on a feature of the moving object.

5. The method of claim 3, wherein the determining whether the moving object velocity condition is satisfied comprises determining whether the velocity of the moving object is equal to or lower than a threshold velocity that corresponds to a predetermined resolution limit.

6. The method of claim 3, wherein the determining whether the stuck condition is satisfied comprises determining, based on the velocity of the moving object being considered, whether signals of the GPS latitude and the GPS longitude are updated at a predefined frequency or within a predefined time interval.

7. The method of claim 1, further comprising:
determining a GPS state and whether gradient calculation is permitted;
updating, based on the determining the GPS state and whether gradient calculation is permitted, the integration of the data;
checking whether an integration time is an integer, wherein the integration time corresponds to a time period during which the integration of the data is performed; and
storing, based on the integration time being the integer, the updated integration of the data in an integration log.

8. The method of claim 7, wherein the determining the integrated altitude value comprises:
determining whether the integration time exceeds a maximum integration time or whether GPS is stuck;
determining, based on the determining whether the integration time exceeds the maximum integration time or whether the GPS is stuck, whether to terminate the GPS;
selecting, based on the determining whether to terminate the GPS:
one of previously integrated altitude values before the GPS is stuck, and
a currently integrated altitude value; and
storing the selected one of the previously integrated altitude values and the currently integrated altitude value for the integration of the data.

9. The method of claim 1, wherein the determining the inclination offset estimation data comprises estimating the inclination offset estimation data by using recursive least squares (RLS) process with input parameters, and
wherein the input parameters comprise:
a GPS-based offset estimation covariance value, which is determined during driving of the moving object, wherein the GPS-based offset estimation covariance value indicates a level of uncertainty in GPS derived data,
an inclination offset estimation count value indicating a number of times the RLS process updates inclination offset estimation, and
a forgetting factor value indicating how much influence older data has compared to newer data in the RLS process.

10. The method of claim 1, wherein the determining the observed inclination offset value comprises restricting, based on a drift in the observed inclination offset value, a gradient estimation error to a predetermined value or below the predetermined value.

11. An apparatus associated with a moving object, the apparatus comprising:
a processor; and
a memory storing an inclinometer offset value and at least one instruction executed by the processor and configured to cause the apparatus to:
obtain data about a velocity of the moving object, a global positioning system (GPS) altitude, a GPS latitude, a GPS longitude and a gradient associated with the moving object,
determine, based on integrating the data, an integrated altitude value,
determine, based on the integrated altitude value through a recursive least squares (RLS) process, an observed inclination offset value,
determine, based on the observed inclination offset value, inclination offset estimation data,
automatically adjust, based on the inclination offset estimation data, the inclinometer offset value of an inclinometer associated with the moving object, and
output a signal indicating the adjusted inclinometer offset value.

12. The apparatus of claim 11, wherein the at least one instruction, executed by the processor, is further configured to cause the apparatus to determine, based on a value indicating consistency of a GPS satisfying a threshold value, the integrated altitude value.

13. The apparatus of claim 12, wherein the at least one instruction, executed by the processor, is further configured to cause the apparatus to determine the consistency of the GPS by determining whether at least one of an altitude change condition, a moving object velocity condition, or a stuck condition is satisfied.

14. The apparatus of claim 13, wherein the at least one instruction, executed by the processor, is further configured to cause the apparatus to determine whether the altitude change condition is satisfied by determining whether a change of the GPS altitude does not exceed a maximum altitude change per hour, wherein the maximum altitude change per hour is determined based on a feature of the moving object.

15. The apparatus of claim 13, wherein the at least one instruction, executed by the processor, is further configured to cause the apparatus to determine whether the moving object velocity condition is satisfied by determining whether the velocity of the moving object is equal to or lower than a threshold velocity that corresponds to a predetermined resolution limit.

16. The apparatus of claim 13, wherein the at least one instruction, executed by the processor, is further configured to cause the apparatus to determine whether the stuck condition is satisfied by determining, based on the velocity of the moving object being considered, whether signals of the GPS latitude and the GPS longitude are updated at a predefined frequency or within a predefined time interval.

17. The apparatus of claim 11, wherein the at least one instruction, executed by the processor, is further configured to cause the apparatus to:
in order to determine the integrated altitude value, determine a GPS state and whether gradient calculation is permitted,
update, based on a determination of the GPS and whether gradient calculation is permitted, the integration of the data,
check whether an integration time is an integer, wherein the integration time corresponds to a time period during which the integration of the data is performed, and
store, based on the integration time being the integer, the updated integration of the data in an integration log.

18. The apparatus of claim 17, wherein the at least one instruction, executed by the processor, is further configured to cause the apparatus to:
in order to determine the integrated altitude value, determine whether the integration time exceeds a maximum integration time or whether GPS is stuck,
determine, based on the determining whether the integration time exceeds the maximum integration time or whether the GPS is stuck, whether to terminate the GPS,
select, based on a determination of whether to terminate the GPS:
one of previously integrated altitude values before the GPS is stuck, and
a currently integrated altitude value, and
store the selected one of the previously integrated altitude values and the currently integrated altitude value for the integration of the data.

19. The apparatus of claim 11, wherein the at least one instruction, executed by the processor, is further configured to cause the apparatus to estimate the inclination offset estimation data by using the RLS process with input parameters in order to determine the inclination offset estimation data, and
wherein the input parameters comprise:
a GPS-based offset estimation covariance value, which is determined during driving of the moving object, wherein the GPS-based offset estimation covariance value indicates a level of uncertainty in GPS derived data,
an inclination offset estimation count value indicating a number of times the RLS process updates inclination offset estimation, and
a forgetting factor value indicating how much influence older data has compared to newer data in the RLS process.

20. The apparatus of claim 11, wherein the at least one instruction, executed by the processor, is further configured to cause the apparatus to restrict, based on a drift in the observed inclination offset value, a gradient estimation error to a predetermined value or below the predetermined value in order to determine the observed inclination offset value.
